(19) United States
(12) Patent Application Publication
(10) Pub. No.: US 2008/0103282 A1
(43) Pub. Date: May 1, 2008

(54) Aqueous Dispersion Type Polyurethane Composition

(75) Inventors: Tamotsu Nagamatsu, Saitama (JP); Fumiaki Murano, Saitama (JP)

Correspondence Address: YOUNG & THOMPSON, 209 Madison Street, Suite 500, ALEXANDRIA, VA, 22314, US

(73) Assignee: Adeka Corporation, Tokyo (JP)

(21) Appl. No.: 10/586,754

(22) PCT Filed: Feb. 2, 2005
(86) PCT No.: PCT/JP05/01480

§ 371 Date: Jul. 21, 2006

(30) Foreign Application Priority Data
Feb. 6, 2004 (JP) 2004-030412

(51) Int. Cl. C08G 18/06

(52) U.S. Cl. 528/61

(57) ABSTRACT

An aqueous dispersion type polyurethane composition is obtained from (a) a polyisocyanate component essentially comprising a diisocyanate and optionally other polyisocyanate compound, (b) a polyol component essentially comprising a polycarbonate diol having an average molecular weight of 500 to 5000 and a carboxyl-containing diol and optionally other polyol compound, (c) an amine component essentially comprising a monoamine compound as an essential component and optionally a diamine compound, (d) a carboxyl-neutralizing component, and (e) water. The composition is suited as a member of automotive intercoating compositions, providing a coating film with good adhesion to surfaces to be coated and satisfactory physical properties. The coating film imparts sufficient impact resistance to coating systems.

### TECHNICAL FIELD

This invention relates to an aqueous dispersion type polyurethane composition having a specific formulation. More particularly, it relates to an aqueous dispersion type polyurethane composition obtained essentially from a polycarbonate diol having an average molecular weight of 500 to 5000, a carboxyl-containing diol, a diisocyanate compound, a monoamine compound, and a carboxyl-neutralizing agent. The composition provides a coating film with good adhesion to a substrate and provides impact resistance.

### BACKGROUND ART

Automotive coatings are usually multilayer systems applied to an electrocoated panel, including an intercoat, a basecoat, and a topcoat. In recent years, waterborne systems for the intercoat and the basecoat have been investigated from the standpoint of the environmental burden and working hygiene. The intercoat is required to serve for preparation of surfaces to finally achieve high quality finish and also to have impact resistance influential on stone-chip resistance.

To solve the above problems, use of an aqueous dispersion type composition as an intercoating composition has been studied. For example, Patent Document 1 discloses a waterborne coating containing a polyester emulsion and an aliphatic polyisocyanate adduct. Patent Document 2 discloses an automotive anti-chip coating containing a polyurethane emulsion and an acrylic emulsion. Patent Document 3 discloses an anti-chip waterborne coating containing a copolymer resin mainly comprised of ethylene and carboxyl-containing ethylenically unsaturated monomer and polyurethane. Patent Document 4 discloses a waterborne coating composition containing a polysiloxy-containing polymer, a copolymer mainly made from an ethylenically unsaturated monomer and a carboxyl-containing ethylenically unsaturated monomer, and an aqueous polyurethane.
Patent Document 1: JP-A-8-209066
Patent Document 2: JP-A-7-166093
Patent Document 3: JP-A-6-9925
Patent Document 4: JP-A-2000-119556

### DISCLOSURE OF THE INVENTION

The performance required of an aqueous dispersion type polyurethane used in an automotive, waterborne intercoating composition is to impart sufficient chip resistance to a coating system. For this it is considered effective that an aqueous dispersion type polyurethane itself provides a coating film having high adhesion to a substrate and capable of imparting impact resistance to the coating system. Taking a combined use with other resins into consideration, an aqueous dispersion type polyurethane is also required not to reduce dispersion stability when formulated into an aqueous dispersion type polyurethane composition having a high solids content.

As a result of extensive investigations, the present inventors have found that an aqueous dispersion type polyurethane composition containing specific components solves the above problems and completed the present invention.

The present invention provides an aqueous dispersion type polyurethane composition obtained from (a) a polyisocyanate component including essentially a diisocyanate and, optionally, other polyisocyanate compound, (b) a polyol component including essentially a polycarbonate diol having an average molecular weight of 500 to 5000 and a carboxyl-containing diol and, optionally, other polyol compound, (c) an amine component including essentially a monoamine compound and, optionally, a diamine compound, (d) a carboxyl-neutralizing component, and (e) water.

### BEST MODE FOR CARRYING OUT THE INVENTION

The diisocyanate, an essential component of the polyisocyanate component (a), is not particularly limited, and commonly known diisocyanate compounds can be used either individually or as a mixture of two or more thereof. Useful diisocyanates include aromatic diisocyanates, such as tolylene diisocyanate, diphenylmethane-4,4′-diisocyanate, p-phenylene diisocyanate, xylylene diisocyanate, 1,5-naphthylene diisocyanate, 3,3′-dimethyldiphenyl-4,4′-diisocyanate, dianisidine diisocyanate, and tetramethylxylylene diisocyanate; alicyclic diisocyanates, such as isophorone diisocyanate, dicyclohexylmethane-4,4′-diisocyanate, trans-1,4-cyclohexyl diisocyanate, and norbornene diisocyanate; and aliphatic diisocyanates, such as 1,6-hexamethylene diisocyanate, 2,2,4- and/or 2,4,4-trimethylhexamethylene diisocyanate, and lysine diisocyanate. Alicyclic diisocyanates are preferred; for the resulting polyurethane molecules and a coating film obtained therefrom are excellent in hydrolysis resistance. Isophorone diisocyanate and dicyclohexylmethane-4,4′-diisocyanate are particularly preferred.

The diisocyanate may be used in a modified form, such as a form modified with carbodiimide, isocyanurate or biuret, or in a blocked form, blocked with various blocking agents. Since a proportion of the diisocyanate in the polyisocyanate component (a) lower than 50% can result in poor compatibility in an intercoating composition, the proportion of the diisocyanate in the polyisocyanate component (a) is preferably 50% or higher, still preferably 70% or higher (by mass).

The other polyisocyanate compound, which is optionally used as the polyisocyanate component (a), is a polyisocyanate having three or more isocyanate groups per molecule. Examples include tri- or higher functional isocyanates, such as isocyanurate or biuret trimers of the above-enumerated diisocyanates, trimethylolpropane adducts, triphenylmethane triisocyanate, 1-methylbenzol-2,4,6-triisocyanate, and dimethyltriphenylmethane tetraisocyanate. These isocyanate compounds may be used in a modified form, modified with carbodiimide, isocyanurate or biuret, or a blocked form, blocked with various blocking agents.

The polycarbonate diol, an essential component of the polyol component (b), has an average molecular weight of 500 to 5000. If its average molecular weight is less than 500, the composition fails to form a coating film with sufficient adhesion to the substrate. If it exceeds 5000, the water dispersion type polyurethane has reduced dispersion stability or fails to provide a coating film with sufficient impact resistance. The diol material of the polycarbonate diol is not particularly limited and can arbitrarily be chosen from low molecular diols, including ethylene glycol, 1,2-propanediol, 1,3-propanediol, 2-methyl-1,3-propanediol, 2-butyl-2-ethyl-1,3-propanediol, 1,4-butanediol, neopentyl glycol, 3-methyl-2,4-pentanediol, 2,4-pentanediol, 1,5-pentanediol, 3-methyl-1,5-pentanediol, 2-methyl-2,4-pentanediol, 2,4-diethyl-1,5-pentanediol, and 1,6-hexanediol. 1,6-Hexanediol is preferred for its low cost and easy availability.

The carboxyl-containing diol, another essential component as the polyol component (b), is used to introduce a hydrophilic group into polyurethane molecules. The hydrophilic group is a neutralized carboxyl group. Examples of the carboxyl-containing diol are dimethylolpropionic acid, dimethylolbutanoic acid, dimethylolbutyric acid, and dimethylolvaleric acid.

The other polyol compound, which is optionally used as the polyol component (b), is not particularly limited, and commonly known polyols can be used either individually or as a mixture of two or more thereof. Useful polyols include low molecular polyols, polyether polyols, polybutadiene polyols, silicone polyols, and polyols having an ester linkage.

The low molecular polyols include aliphatic diols, such as ethylene glycol, 1,2-propanediol, 1,3-propanediol, 2-methyl-1,3-propanediol, 2-butyl-2-ethyl-1,3-propanediol, 1,4-butanediol, neopentyl glycol, 3-methyl-2,4-pentanediol, 2,4-pentanediol, 1,5-pentanediol, 3-methyl-1,5-pentanediol, 2-methyl-2,4-pentanediol, 2,4-diethyl-1,5-pentanediol, 1,6-hexanediol, 1,7-heptanediol, 3,5-heptanediol, 1,8-octanediol, 2-methyl-1,8-octanediol, 1,9-nonanediol, 1,10-decanediol, diethylene glycol, and triethylene glycol; alicyclic diols, such as cyclohexanedimethanol and cyclohexanediol; and trihydric or higher polyhydric alcohols, such as trimethylolethane, trimethylolpropane, hexitols, pentitols, glycerol, pentaerythritol, and tetramethylolpropane.

The polyether polyols include ethylene oxide and/or propylene oxide adducts of the above-enumerated low molecular polyols, and polytetramethylene glycol.

The silicone polyols include silicone oils having a siloxane bond in the molecule and a hydroxyl group at the terminals.

The polyols having an ester linkage include polyester polyols and polyester polycarbonate polyols.

The polyester polyols include those obtained by direct esterification and/or interesterification between the low molecular polyol exemplified above and less than the stoichiometric amount of a polycarboxylic acid or its ester-forming derivative (e.g., ester, anhydride or halide). Examples of the polycarboxylic acid or its ester-forming derivative include aliphatic dicarboxylic acids, such as oxalic acid, malonic acid, succinic acid, glutaric acid, adipic acid, pimelic acid, suberic acid, azelaic acid, sebacic acid, dodecanedicarboxylic acid, 2-methylsuccinic acid, 2-methyladipic acid, 3-methyladipic acid, 3-methylpentanedicarboxylic acid, 2-methyloctanedicarboxylic acid, 3,8-dimethyldecanedicarboxylic acid, 3,7-dimethyldecanedicarboxylic acid, hydrogenated dimer acid, and dimer acid; aromatic dicarboxylic acids, such as phthalic acid, terephthalic acid, isophthalic acid, and naphthalenedicarboxylic acid; alicyclic dicarboxylic acids, such as 1,2-cyclopentanedicarboxylic acid, 1,3-cyclopentanedicarboxylic acid, 1,2-cyclohexanedicarboxylic acid, 1,3-cyclohexanedicarboxylic acid, 1,4-cyclohexanedicarboxylic acid, 1,4-dicarboxylmethylenecyclohexane, nadic acid, and methylnadic acid; and tricarboxylic acids, such as trimellitic acid, trimesic acid, and castor oil fatty acid trimer; and derivatives of these polycarboxylic acids including acid anhydrides, halides (e.g., chloride and bromide), lower alkyl esters (e.g., methyl ester, ethyl ester, propyl ester, isopropyl ester, butyl ester, isobutyl ester, and amyl ester), and lactones (e.g., γ-caprolactone, δ-caprolactone, ε-caprolactone, dimethyl-ε-caprolactone, δ-valerolactone, γ-valerolactone, and γ-butyrolactone.

When the proportion of the polycarbonate diol having an average molecular weight of 500 to 5000 in the polyol component (b) is less than 50% by mass, the coating film can fail to exhibit sufficient strength. When it is more than 97% by mass, the polyurethane can have poor water dispersibility. Accordingly, the proportion is preferably 50% to 97% by mass, still preferably 75% to 95% by mass. When the proportion of the carboxyl-containing diol is less than 3% by mass, the polyurethane can fail to have sufficient water dispersibility. When it is more than 30% by mass, the resulting coating film can have poor strength and water resistance. The proportion is preferably 3% to 30% by mass, still preferably 5% to 25% by mass.

The monoamine compound, an essential component as the amine component (c), is not particularly limited, and commonly known monoamine compounds can be used either individually or as a mixture of two or more thereof. Useful monoamine compounds include alkylamines, such as ethylamine, propylamine, 2-propylamine, butylamine, 2-butylamine, tert-butylamine, and isobutylamine; aromatic amines, such as aniline, methylaniline, phenylnaphtylamine, and naphthylamine; alicyclic amines, such as cyclohexaneamine and methylcyclohexaneamine; ether amines, such as 2-methoxyethylamine, 3-methoxypopylamine, and 2-(2-methoxyethoxy)ethylamine; and alkanolamines, such as ethanolamine, propanolamine, butylethanolamine, 1-amino-2-methyl-2-propanol, 2-amino-2-methylpropanol, diethanolamine, diisopropanolamine, dimethylaminopropylethanolamine, dipropanolamine, N-methylethanolamine, and N-ethylethanolamine. Preferred of them are alkanolamines; for they impart good water dispersion stability to polyurethane molecules. Still preferred are 2-aminoethanol and diethanolamine for their low cost.

The diamine compound, an optional component as the amine component (c), is not particularly limited, and commonly known diamine compounds can be used either individually or as a mixture of two or more thereof. Examples of the diamine compound include low molecular diamines that are low molecular diols as exemplified above with their alcoholic hydroxyl group displaced with an amino group, such as ethylene diamine and propylenediamine; polyether diamines, such as polyoxypropylenediamine and polyoxyethylenediamine; alicyclic diamines, such as menthenediamine, isophoronediamine, norbornenediamine, bis(4-amino-3-methyldicyclohexyl)methane, diaminodicyclohexylmethane, bis(aminomethyl)cyclohexane, and 3,9-bis(3-aminopropyl)-2,4,8,10-tetraoxaspiro(5,5)undecane; aromatic diamines, such as m-xylenediamine, α-(m/p-aminophenol)ethylamine, m-phenylenediamine, diaminodiphenylmethane, diaminodiphenylsulfone, diaminodiethyldimethyldiphenylmethane, diaminodiethyldiphenylmethane, dimethylthiotoluenediamine, diethyltoluenediamine, and α,α′-bis(4-aminophenyl)-p-diisopropylbenzene; hydrazine; and dicarboxylic acid dihydrazide compounds formed between the dicarboxylic acid exemplified as a polycarboxylic acid used to make the polyester polyols and hydrazine. Preferred of these diamine compounds are low molecular diamines for their low cost. Ethylenediamine is still preferred.

When the proportion of the diamine compound as an optional component in the amine component (c) is less than 5 mol %, the resulting coating film can have insufficient strength. When it is more than 99 mol %, the polyurethane can have too high a molecular weight to be stable in aqueous dispersion. Accordingly, the proportion is preferably 5 to 99 mol %, still preferably 5 to 95 mol %, even still preferably 5 to 50%.

A neutralizing agent that can be used as a carboxyl-neutralizing component (d) is a basic compound capable of reacting with a carboxyl group to form a hydrophilic salt. Such a basic compound includes tertiary amine compounds, such as trialkylamines, e.g., trimethylamine, triethylamine, and tributylamine; N,N-dialkylalkanolamines, e.g., N,N-dimethylethanolamine, N,N-dimethylpropanolamine, N,N-dipropylethanolamine, and 1-dimethylamino-2-methyl-2-propanol; N-alkyl-N,N-dialkanolamines; and trialkanolamines, e.g., triethanolamine; ammonia, trimethylammonium hydroxide, sodium hydroxide, potassium hydroxide, and lithium hydroxide. Among them the tertiary amine compounds are preferred in that the resulting aqueous dispersion type polyurethane composition has good dispersion stability.

The aqueous dispersion type polyurethane composition of the invention may contain an internal branching agent or an internal crosslinking agent for introducing an internal branched or crosslinked structure into the polyurethane molecules. Useful internal branching agents or crosslinking agents include melamine and methylolmelamine.

The method of preparing the aqueous dispersion type polyurethane composition of the invention is not particularly restricted, and any known method can be used. In a preferred method, a prepolymer or a polymer is synthesized in a solvent inert to the reaction and having high affinity to water, and the product is fed to water and dispersed therein. For example, a prepolymer is synthesized from the polyisocyanate component (a) and the polyol component (b), which is then allowed to react with the amine component (c) in water (method A for future reference), or a polymer is synthesized from the polyisocyanate component (a), the polyol component (b), and the amine component (c), which is then fed to water and dispersed (method B). The carboxyl-neutralizing component (d) may be added to water either before or after the feed to water.

Method A is preferred in view of ease of control of composition and reaction and good dispersibility.

The solvent inert to the reaction and having high water affinity that can be used in method A includes acetone, methyl ethyl ketone, dioxane, tetrahydrofuran, and N-methyl-2-pyrrolidone. The solvent is usually used in an amount of 3% to 100% by mass based on the total amount of the starting materials used to prepare the prepolymer or polymer

In the preparation of the aqueous dispersion type polyurethane composition of the invention, the compounding ratio of the components is not particularly limited. The compounding ratio is selected based on the molar ratios of the isocyanate group content in the polyisocyanate component (a) to the isocyanate-reactive groups of the polyol component (b) and the amine component (c) in a system ready to react. Where the dispersed polyurethane molecules are short of unreacted isocyanate group content, the resulting coating film can have reduced adhesion or strength. On the other hand, an excessive unreacted isocyanate group content can affect the dispersion stability or physical properties of the coating. Hence, it is preferred that the ratio of the sum of the moles of hydroxyl group in the polyol component (b) and the moles of amino group in the amine component (c) to the moles of isocyanate group in the polyisocyanate component (a) be selected from the range of from 0.50 to 2.0. It is also preferred that the ratio of the moles of hydroxyl group in the polyol component (b) to the moles of isocyanate group in the polyisocyanate component (a) be 0.3 to 1.0, still preferably 0.5 to 0.9. It is also preferred that the ratio of the moles of amino group in the amine component (c) to the moles of isocyanate group in the polyisocyanate component (a) be 0.1 to 1.0, still preferably 0.2 to 0.5.

The degree of neutralization by the carboxyl-neutralizing component (d) is selected so that the resulting aqueous dispersion type polyurethane composition may have sufficient dispersion stability. The amount of the neutralizer is preferably 0.5 to 2.0 molar equivalents, still preferably 0.7 to 1.5 molar equivalents, relative to the carboxyl group of the polyol component (a)

The aqueous dispersion type polyurethane composition of the invention takes on such forms as emulsion, suspension, colloidal dispersion, and aqueous solution. To stabilize the dispersibility, one or more emulsifiers such as surface active agents may be added. The size of the particles dispersed or suspended in water in the form of emulsion, suspension or colloidal dispersion is not particularly limited but is preferably 1 μm or smaller, still preferably 500 μm or smaller, to maintain a good dispersion condition.

Useful emulsifiers include anionic surface active agents, nonionic surface active agents, cationic surface active agents, amphoteric surface active agents, polymeric surface active agents, and reactive surface active agents that are commonly known for application to aqueous dispersion type polyurethanes. In using a surface active agent, anionic, nonionic or cationic surface active agents are preferred in view of low cost and satisfactory emulsification.

Examples of the anionic surface active agents include alkylsulfates, such as sodium dodecylsulfate, potassium dodecylsulfate, and ammonium dodecylsulfate; sodium dodecyl polyglycol ether sulfate; sodium sulforicinoleate; alkyl sulfonates, such as sulfonated paraffin alkali metal salts and sulfonated paraffin ammonium salt; fatty acid salts, such as sodium laurate, triethanolamine oleate and triethanolamine abietate; alkylaryl sulfonates, such as sodium benzenesulfonate and an alkali metal sulfate of alkylphenol hydroxyethylene; higher alkylnaphthalenesulfonates; naphthalenesulfonic acid formalin condensates; dialkylsulfosuccinates; polyoxyethylene alkylsulfate salts; and polyoxyethylene alkylarylsulfate salts.

Examples of the nonionic surface active agents include ethylene oxide and/or propylene oxide adducts of alcohols having 1 to 18 carbon atoms, ethylene oxide and/or propylene oxide adducts of alkylphenols, and ethylene oxide and/or propylene oxide adducts of alkylene glycols and/or alkylenediamines.

With reference to the components constituting the nonionic surface active agents, the alcohols having 1 to 18 carbon atoms include methanol, ethanol, propanol, 2-propanol, butanol, 2-butanol, tert-butanol, amyl alcohol, isoamyl alcohol, tert-amyl alcohol, hexanol, octanol, decane alcohol, lauryl alcohol, myristyl alcohol, palmityl alcohol, and stearyl alcohol. The alkylphenols include phenol, methylphenol, 2,4-di-tert-butylphenol, 2,5-di-tert-butylphenol, 3,5-di-tert-butylphenol, 4-(1,3-tetramethylbutyl)phenol, 4-isooctylphenol, 4-nonylphenol, 4-tert-octylphenol, 4-dodecylphenol, 2-(3,5-dimethylheptyl)phenol, 4-(3,5-dimethylheptyl)phenol, naphthol, bisphenol A, and bisphenol F. The alkylene glycols include ethylene glycol, 1,2-propanediol, 1,3-propanediol, 2-methyl-1,3-propanediol, 2-butyl-2-ethyl-1,3-propanediol, 1,4-butanediol, neopentyl glycol, 1,5-pentanediol, 3-methyl-1,5-pentanediol, 2,4-diethyl-1,5-pentanediol, and 1,6-hexanediol. The alkylenediamines include the alkylene glycols exemplified above with their alcoholic hydroxyl group displaced with an amino group. The ethylene oxide and/or propylene oxide adducts may be random adducts or block adducts.

The cationic surface active agents include primary, secondary and tertiary amine salts, pyridinium salts, alkylpyridinium salts, and quaternary ammonium salts such as alkyl quaternary ammonium halides.

The amount of the emulsifier to be used if necessary is arbitrarily selected with no particular limitation. Nevertheless, addition at a mass ratio of 0.01 or smaller to the polyurethane compound can fail to secure sufficient dispersibility. If the ratio exceeds 0.3, there is a fear that a product of the aqueous dispersion type polyurethane composition, such as a coating film, may have reduced physical properties, such as water resistance, strength, and elongation. From this point of view, the ratio is preferably 0.01 to 0.3, still preferably 0.05 to 0.2

The solids content of the aqueous dispersion type polyurethane composition of the invention is arbitrarily selected with no particular limitation. In view of dispersibility and coating properties, a recommended solids content is 10% to 70% by mass, preferably 20% to 60% by mass.

The polyurethane dispersed in the aqueous dispersion type polyurethane composition of the invention is not particularly limited in average molecular weight. The average molecular weight can be chosen from a range that assures dispersibility as a waterborne coating and provides a satisfactory coating film. A preferred average molecular weight is 5000 to 200000, and still preferred is 10000 to 50000. The hydroxyl value of the polyurethane is not limited but usually ranges from 1 to 100 in terms of amount (mg) of KOH consumed per gram of the resin.

The physical properties of the aqueous dispersion type polyurethane composition of the invention are preferably such that provide a coating film with improved chip resistance. In this connection, important is the balance between elongation and tensile strength in view of impact absorption and energy transport. A coating film with high elongation and low tensile strength tends to suffer from wide damage from chipping. A coating film with low elongation and high tensile strength tends to suffer from deep damage from chipping. The properties of the polyurethane composition of the invention that provide ensured chip resistance are as follows. In a tensile test (pulling speed: 500 mm/min; span length: 40 mm) on a dumbbell specimen (JIS No. 2; thickness: 150 μm) prepared by drying at 25° C. for 12 hours followed by heat curing at 120° C. for 1 hour, the tensile strength ranges from 10 to 100 MPa, the elongation ranges 100% to 1000%, and the tensile strength (MPa)/elongation (%) ratio ranges 0.01 to 0.5.

If desired, the aqueous dispersion type polyurethane composition of the invention may contain various additives commonly known in the art. Such additives include pigments, dyes, film forming assistants, curing agents, silane coupling agents, anti-blocking agents, viscosity modifiers, leveling agents, defoaming agents, anti-gelling agents, dispersion stabilizers, hindered amine light stabilizers, antioxidants, UV absorbers, radical scavengers, heat resistance imparting agents, inorganic or organic fillers, plasticizers, lubricants, antistatics, reinforcing agents, catalysts, thixotropic agents, antibacterial agents, antifungal agents, and anti-corrosive agents.

In particular, since the aqueous dispersion type polyurethane composition of the invention is mostly used in automotive exterior coating systems, addition of hindered amine light stabilizers, UV absorbers, and phosphorus, phenol or sulfur antioxidants are advisable.

Examples of the hindered amine light stabilizers include 2,2,6,6-tetramethyl-4-piperidyl stearate, 1,2,2,6,6-pentamethyl-4-piperidyl stearate, 2,2,6,6-tetramethyl-4-piperidyl benzoate, bis(2,2,6,6-tetramethyl-4-piperidyl)sebacate, bis(1,2,2,6,6-pentamethyl-4-piperidyl)sebacate, bis(1-octyloxy-2,2,6,6-tetramethyl-4-piperidyl)sebacate, 1,2,2,6,6-pentamethyl-4-piperidyl methylmethacrylate, 2,2,6,6-tetramethyl-4-piperidyl methylmethacrylate, tetrakis(2,2,6,6-tetramethyl-4-piperidyl)-1,2,3,4-butanetetracarboxylate, tetrakis(1,2,2,6,6-pentamethyl-4-piperidyl)-1,2,3,4-butanetetracarboxylate, bis(2,2,6,6-tetramethyl-4-piperidyl).bis(tridecyl)-1,2,3,4-butanetetracarboxylate, bis(1,2,2,6,6-pentamethyl-4-piperidyl).bis(tridecyl)-1,2,3,4-butanetetracarboxylate, bis(1,2,2,6,6-pentamethyl-4-piperidyl)-2-butyl-2-(3,5-di-tert-butyl-4-hydroxybenzyl)malonate, 1-(2-hydroxyethyl)-2,2,6,6-tetramethyl-4-piperidinol/diethyl succinate polycondensate, 1,6-bis(2,2,6,6-tetramethyl-4-piperidylamino)hexane/dibromoethane polycondensate, 1,6-bis(2,2,6,6-tetramethyl-4-piperidylamino)hexane/2,4-dichloro-6-morpholino-s-triazine polycondensate, 1,6-bis(2,2,6,6-tetramethyl-4-piperidylamino)hexane/2,4-dichloro-6-tert-octylamino-s-triazine polycondensate, 1,5,8,12-tetrakis[2,4-bis(N-butyl-N-(2,2,6,6-tetramethyl-4-piperidyl)amino)-s-triazin-6-yl]-1,5,8,12-tetraazadodecane, 1,5,8,12-tetrakis[2,4-bis(N-butyl-N-(1,2,2,6,6-pentamethyl-4-piperidyl)amino)-s-triazin-6-yl]-1,5,8,12-tetraazadodecane, 1,6,11-tris[2,4-bis(N-butyl-N-(2,2,6,6-tetramethyl-4-piperidyl)amino)-s-triazin-6-ylamino]undecane, 1,6,11-tris[2,4-bis(N-butyl-N-(1,2,2,6,6-pentamethyl-4-piperidyl)amino)-s-triazin-6-ylamino]undecane, 3,9-bis[1,1-dimethyl-2-[tris(2,2,6,6-tetramethyl-4-piperidyloxycarbonyloxy)butylcarbonyloxy]ethyl]-2,4,8,10-tetraoxaspiro[5.5]undecane, and 3,9-bis[1,1-dimethyl-2-[tris(1,2,2,6,6-pentamethyl-4-piperidyloxycarbonyloxy)butylcarbonyloxy]ethyl]-2,4,8,10-tetraoxaspiro[5.5]undecane.

Examples of the UV absorbers include 2-hydroxybenzophenones, such as 2,4-dihydroxybenzophenone, 2-hydroxy-4-methoxybenzophenone, 2-hydroxy-4-octyloxybenzophenone, and 5,5′-methylenebis(2-hydroxy-4-methoxybenzophenone); 2-(2-hydroxyphenyl)benzotriazoles, such as 2-(2-hydroxy-5-methylphenyl)benzotriazole, 2-(2-hydroxy-5-tert-octylphenyl)benzotriazole, 2-(2-hydroxy-3,5-di-tert-butylphenyl)-5-chlorobenzotriazole, 2-(2-hydroxy-3-tert-butyl-5-methylphenyl)-5-chlorobenzotriazole, 2-(2-hydroxy-3,5-dicumylphenyl)benzotriazole, 2,2′-methylenebis(4-tert-octyl-6-benzotriazolyl)phenol, polyethylene glycol ester of 2-(2-hydroxy-3-tert-butyl-5-carboxyphenyl)benzotriazole, 2-[2-hydroxy-3-(2-acryloyloxyethyl)-5-methylphenyl]benzotriazole, 2-[2-hydroxy-3-(2-methacryloyloxyethyl)-5-tert-butylphenyl]benzotriazole, 2-[2-hydroxy-3-(2-methacryloyloxyethyl)-5-tert-octylphenyl]benzotriazole, 2-[2-hydroxy-3-(2-methacryloyloxyethyl)-5-tert-butylphenyl]-5-chlorobenzotriazole, 2-[2-hydroxy-5-(2-methacryloyloxyethyl)phenyl]benzotriazole, 2-[2-hydroxy-3-tert-butyl-5-(2-methacryloyloxyethyl)phenyl]benzotriazole, 2-[2-hydroxy-3-tert-amyl-5-(2-methacryloyloxyethyl)phenyl]benzotriazole, 2-[2-hydroxy-3-tert-butyl-5-(3-methacryloyloxypropyl)phenyl]-5-chlorobenzotriazole, 2-[2-hydroxy-4-(2-methacryloyloxymethyl)phenyl]benzotriazole, 2-[2-hydroxy-4-(3-methacryloyloxy-2-hydroxypropyl)phenyl]benzotriazole, and 2-[2-hydroxy-4-(3-methacryloyloxypropyl)phenyl]benzotriazole; 2-(2-hydroxyphenyl)-4,6-diaryl-1,3,5-triazines, such as 2-(2-hydroxy-4-methoxyphenyl)-4,6-diphenyl-1,3,5-triazine, 2-(2-hydroxy-4-hexyloxyphenyl)-4,6-diphenyl-1,3,5-triazine, 2-(2-hydroxy-4-octoxyphenyl)-4,6-bis(2,4-dimethylphenyl)-1,3,5-triazine, 2-[2-hydroxy-4-(3-C₁₂₋₁₃ mixed alkoxy-2-hydroxypropoxy)phenyl]-4,6-bis(2,4-dimethylphenyl)-1,3,5-triazine, 2-[2-hydroxy-4-(2-acryloyloxyethoxy)phenyl]-4,6-bis(4-methylphenyl)-1,3,5-triazine, 2-(2,4-dihydroxy-3-allylphenyl)-4,6-bis(2,4-dimethylphenyl)-1,3,5-triazine, and 2,4,6-tris(2-hydroxy-3-methyl-4-hexyloxyphenyl)-1,3,5-triazine; benzoates, such as phenyl salicylate, resorcinol monobenzoate, 2,4-di-tert-butylphenyl 3,5-di-tert-butyl-4-hydroxybenzoate, octyl (3,5-di-tert-butyl-4-hydroxy)benzoate, dodecyl (3,5-di-tert-butyl-4-hydroxy)benzoate, tetradecyl (3,5-di-tert-butyl-4-hydroxy)benzoate, hexadecyl (3,5-di-tert-butyl-4-hydroxy)benzoate, octadecyl (3,5-di-t-butyl-4-hydroxy)benzoate, and behenyl (3,5-di-tert-butyl-4-hydroxy)benzoate; substituted oxanilides, such as 2-ethyl-2′-ethoxyoxanilide and 2-ethoxy-4′-dodecyloxanilide; cyanoacrylates, such as ethyl α-cyano-β,β-diphenylacrylate and methyl 2-cyano-3-methyl-3-(p-methoxyphenyl)acrylate; and metal salts or chelates, particularly nickel or chromium salts or chelates.

Examples of the phosphorus antioxidants include triphenyl phosphite, tris(2,4-di-tert-butylphenyl)phosphite, tris(2,5-di-tert-butylphenyl)phosphite, tris(nonylphenyl)phosphite, tris(dinonylphenyl)phosphite, tris(mono-/di-mixed nonylphenyl)phosphite, diphenyl acid phosphite, 2,2′-methylenebis(4,6-di-tert-butylphenyl)octyl phosphite, diphenyl decyl phosphite, diphenyl octyl phosphite, di(nonylphenyl)pentaerythritol diphosphite, phenyl diisodecyl phosphite, tributyl phosphite, tris(2-ethylhexyl)phosphite, tridecyl phosphite, trilauryl phosphite, dibutyl acid phosphite, dilauryl acid phosphite, trilauryl trithiophosphite, bis(neopentyl glycol) 1,4-cyclohexanedimethyl diphosphite, bis(2,4-di-tert-butylphenyl)pentaerythritol diphosphite, bis(2,5-di-tert-butylphenyl)pentaerythritol diphosphite, bis(2,6-di-tert-butyl-4-methylphenyl)pentaerythritol diphosphite, bis(2,4-dicumylphenyl)pentaerythritol diphosphite, distearyl pentaerythritol diphosphite, tetra(C₁₂₋₁₅-mixed alkyl)4,4′-isopropylidenediphenyl phosphite, bis[2,2′-methylenebis(4,6-diamylphenyl)]isopropylidenediphenyl phosphite, tetratridecyl-4,4′-butylidenebis(2-tert-butyl-5-methylphenyl)diphosphite, hexa(tridecyl)-1,1,3-tris(2-methyl-5-tert-butyl-4-hydroxyphenyl)butane triphosphite, tetrakis(2,4-di-tert-butylphenyl)biphenylene diphosphonite, tris(2-[(2,4,7,9-tetrakis-tert-butyldibenzo[d,f][1,3,2]dioxaphosphepin-6-yl)oxy]ethyl)amine, 9,10-dihydro-9-oxa-10-phosphaphenanthrene-10-oxide, and 2-butyl-2-ethylpropanediol-2,4,6-tri-tert-butylphenol monophosphite.

Examples of the phenol antioxidants include 2,6-di-tert-butyl-p-cresol, 2,6-diphenyl-4-octadecyloxyphenol, stearyl (3,5-di-tert-butyl-4-hydroxyphenyl)propionate, distearyl (3,5-di-tert-butyl-4-hydroxybenzyl)phosphonate, tridecyl-3,5-di-tert-butyl-4-hydroxybenzyl thioacetate, thiodiethylenebis[(3,5-di-tert-butyl-4-hydroxyphenyl)propionate], 4,4′-thiobis(6-tert-butyl-m-cresol), 2-octylthio-4,6-di(3,5-di-tert-butyl-4-hydroxyphenoxy)-s-triazine, 2,2′-methylenebis(4-methyl-6-tert-butylphenol), bis[3,3-bis(4-hydroxy-3-tert-butylphenyl)butyric acid]glycol ester, 4,4′-butylidenebis(2,6-di-tert-butylphenol), 4,4′-butylidenebis(6-tert-butyl-3-methylphenol), 2,2′-ethylidenebis(4,6-di-tert-butylphenol), 1,1,3-tris(2-methyl-4-hydroxy-5-tert-butylphenyl)butane, bis[2-tert-butyl-4-methyl-6-(2-hydroxy-3-tert-butyl-5-methylbenzyl)phenyl]terephthalate, 1,3,5-tris(2,6-dimethyl-3-hydroxy-4-tert-butylbenzyl)isocyanurate, 1,3,5-tris(3,5-di-tert-butyl-4-hydroxybenzyl)isocyanurate, 1,3,5-tris(3,5-di-tert-butyl-4-hydroxybenzyl)-2,4,6-trimethylbenzene, 1,3,5-tris[(3,5-di-tert-butyl-4-hydroxyphenyl)propionyloxyethyl]isocyanurate, tetrakis[methylene-3-(3′,5′-di-tert-butyl-4′-hydroxyphenyl)propionate]methane, 2-tert-butyl-4-methyl-6-(2-acryloyloxy-3-tert-butyl-5-methylbenzyl)phenol, 3,9-bis[2-(3-tert-butyl-4-hydroxy-5-methylhydrocinnamoyloxy)-1,1-dimethylethyl]-2,4,8,10-tetraoxaspiro[5.5]undecane, and triethylene glycol bis[β-(3-tert-butyl-4-hydroxy-5-methylphenyl)propionate].

Examples of the sulfur antioxidants include dialkyl thiodipropionates, such as a dilauryl, dimyristyl, myristylstearyl or distearyl ester of thiodipropionic acid; and polyol β-alkylmercaptopropionic acid esters, such as pentaerythritol tetra(β-dodecylmercaptopropionate).

The hindered amine light stabilizer, antioxidant, and UV absorber can fail to produce sufficient effects of addition when each added in an amount less than 0.001 parts by mass per 100 parts by mass of the solids content of the aqueous dispersion type polyurethane composition. If added in amounts more than 10 parts by mass, they may affect the dispersibility and physical properties of coating. Accordingly, the amount of each of these additives is preferably 0.001 to 10 parts by mass, still preferably 0.01 to 5 parts by mass. The hindered amine light stabilizer, antioxidant, and UV absorber can be incorporated into the composition by, for example, addition to the polyol component, addition to a prepolymer, addition to an aqueous phase in dispersing, or addition after dispersing in water. In view of ease of operation, addition to the polyol component or a prepolymer is preferred.

### EXAMPLES

The present invention will now be illustrated in greater detail with reference to Examples, Comparative Examples, and Evaluation Examples, but it should be understood that the invention is not limited thereto.

### Example 1

### Preparation of Aqueous Dispersion Type Polyurethane Composition No. 1

In a reaction flask were put 0.26 parts by mole of a polycarbonate diol prepared from 1,6-hexanediol and having a molecular weight of 2000, 1.0 part by mole of isophorone diisocyanate, 0.36 parts by mole of dimethylolpropionic acid, and 39% by mass, based on the total mass of the three materials recited, of N-methyl-2-pyrrolidone and allowed to react at 125° C. for 2 hours in a nitrogen stream. To the reaction system was added 0.47 parts by mole of triethylamine, followed by stirring for 1 hour to obtain a prepolymer. A 100 g portion of the thus prepared prepolymer was added dropwise over 15 minutes to 120 g of water having dissolved therein 0.05 g of a silicone-based antifoaming agent SE-21 (from Wacker Silicone Corp.). To the mixture was further added 2.4 g of monoethanolamine, followed by stirring at 40° C. until an IR absorption peak assigned to isocyanate group disappeared to obtain aqueous dispersion type polyurethane composition No. 1 having a solids content of 31.5% by mass. As a result of GPC analysis under the conditions below, the average molecular weight of the dispersed polyurethane was found to be 22000.

### Molecular Weight Measurement Conditions:

| | |
|---|---|
| Column: | TSKgel G4000, G3000, G2000 |
| Eluent: | THF |
| Flow rate: | 1.000 ml/min |
| Detection: | UV (245 nm) |
| Standard: | PST |

### Example 2

### Preparation of Aqueous Dispersion Type Polyurethane Composition No. 2

In a reaction flask were put 0.26 parts by mole of a polycarbonate diol prepared from 1,6-hexanediol and having a molecular weight of 2000, 1.0 part by mole of dicyclohexylmethane 4,4′-diisocyanate, 0.36 parts by mole of dimethylolpropionic acid, and 40% by mass, based on the total mass of the three materials recited, of N-methyl-2-pyrrolidone and allowed to react at 125° C. for 2 hours in a nitrogen stream to obtain a prepolymer. A 500 g portion of the thus prepared prepolymer was added dropwise over 15 minutes to 600 g of water having dissolved therein 0.25 g of a silicone-based antifoaming agent SE-21 (from Wacker Silicone Corp.), 22.0 g of triethylamine, 0.315 g of ethylenediamine, and 5.35 g of monoethanolamine. The mixture was further stirred at 40° C. for 30 minutes until an IR absorption peak assigned to isocyanate group disappeared to obtain aqueous dispersion type polyurethane composition No. 2 having a solids content of 32.0% by mass. The dispersed polyurethane was found to have an average molecular weight of 30000 as measured in the same manner as in Example 1.

### Example 3

### Preparation of Aqueous Dispersion Type Polyurethane Composition No. 3

In a reaction flask were put 0.26 parts by mole of a polycarbonate diol prepared from 1,6-hexanediol and having a molecular weight of 2000, 1.0 part by mole of dicyclohexylmethane 4,4′-diisocyanate, 0.36 parts by mole of dimethylolpropionic acid, and 39% by mass, based on the total mass of the three materials recited, of N-methyl-2-pyrrolidone and allowed to react at 125° C. for 2 hours in a nitrogen stream to obtain a prepolymer. A 100 g portion of the thus prepared prepolymer was added dropwise over 15 minutes to 120 g of water having dissolved therein 0.05 g of a silicone-based antifoaming agent SE-21 (from Wacker Silicone Corp.), 3.94 g of triethylamine, 0.31 g of ethylenediamine, and 1.78 g of monoethanolamine. The mixture was further stirred at 40° C. for 30 minutes until an IR absorption peak assigned to isocyanate group disappeared to obtain aqueous dispersion type polyurethane composition No. 3 having a solids content of 31.6% by mass. The dispersed polyurethane was found to have an average molecular weight of 48000 as measured in the same manner as in Example 1.

### Example 4

### Preparation of Aqueous Dispersion Type Polyurethane Composition No. 4

In a reaction flask were put 0.34 parts by mole of a polycarbonate diol prepared from 1,6-hexanediol and having a molecular weight of 1000, 1.0 part by mole of dicyclohexylmethane 4,4′-diisocyanate, 0.36 parts by mole of dimethylolpropionic acid, and 40% by mass, based on the total mass of the above three materials, of N-methyl-2-pyrrolidone and allowed to react at 125° C. for 2 hours in a nitrogen stream to obtain a prepolymer. A 100 g portion of the thus prepared prepolymer was added dropwise over 15 minutes to 120 g of water having dissolved therein 0.05 g of a silicone-based antifoaming agent SE-21 (from Wacker Silicone Corp.), 5.00 g of triethylamine, 0.62 g of ethylenediamine, and 2.16 g of monoethanolamine. The mixture was further stirred at 40° C. for 30 minutes until an IR absorption peak assigned to isocyanate group disappeared to obtain aqueous dispersion type polyurethane composition No. 4 having a solids content of 31.7% by mass. The dispersed polyurethane was found to have an average molecular weight of 17000 as measured in the same manner as in Example 1.

### Example 5

### Preparation of Aqueous Dispersion Type Polyurethane Composition No. 5

In a reaction flask were put 0.12 parts by mole of a polycarbonate diol prepared from 1,6-hexanediol and having a molecular weight of 1000, 0.16 parts by mole of melamine, 0.27 parts by mole of dimethylolpropionic acid, 1.0 part by mole of dicyclohexylmethane 4,4′-diisocyanate, and 60% by mass, based on the total mass of the above three materials, of N-methyl-2-pyrrolidone and allowed to react at 125° C. for 2 hours in a nitrogen stream. To the reaction system was added 0.27 parts by mole of triethylamine, followed by stirring for 1 hour to obtain a prepolymer. A 100 g portion of the thus prepared prepolymer was added dropwise over 15 minutes to 117 g of water having dissolved therein 0.05 g of a silicone-based antifoaming agent SE-21 (from Wacker Silicone Corp.). To the reaction system were further added 1.2 g of ethylenediamine, 1.2 g of monoethanolamine, and 1.3 g of adipic acid dihydrazide. The mixture was stirred at 40° C. until an IR absorption peak assigned to isocyanate group disappeared to obtain aqueous dispersion type polyurethane composition No. 5 having a solids content of 29.0% by mass. The dispersed polyurethane was found to have an average molecular weight of 200000 as measured in the same manner as in Example 1, except for using DMSO as a solvent.

### Comparative Example 1

Comparative aqueous dispersion type polyurethane composition 1 having a solids content of 32.2% by mass was prepared in the same manner as in Example 2, except for replacing the polycarbonate diol prepared from 1,6-hexanediol and having a molecular weight of 2000 by a polyester diol prepared from adipic acid and 1,6-hexanediol and having a molecular weight of 2000. The dispersed polyurethane was found to have an average molecular weight of 30000 as measured in the same manner as in Example 1.

### Comparative Example 2

Comparative aqueous dispersion type polyurethane composition 2 having a solids content of 32.1% by mass was prepared in the same manner as in Example 2, except for replacing the polycarbonate diol prepared from 1,6-hexanediol and having a molecular weight of 2000 by a polyester diol prepared from terephthalic acid and 1,6-hexanediol and having a molecular weight of 2000. The dispersed polyurethane was found to have an average molecular weight of 30000 as measured in the same manner as in Example 1.

### Comparative Example 3

Comparative aqueous dispersion type polyurethane composition 3 having a solids content of 32.2% by mass was prepared in the same manner as in Example 2, except for replacing the polycarbonate diol prepared from 1,6-hexanediol and having a molecular weight of 2000 by polyethylene glycol having a molecular weight of 2000. The dispersed polyurethane was found to have an average molecular weight of 30000 as measured in the same manner as in Example 1.

### Evaluation Example 1

### Evaluation of Adhesion

Each of the aqueous dispersion type polyurethane compositions prepared in Examples 1 to 4 and Comparative Examples 1 to 3 was applied to an electrocoated steel sheet and heated at 150° C. for 30 minutes to form a 25 μm thick coating film. The test piece was bent 90 with the coated side out. The coating film at the bend was inspected for any crack with a magnifier. A pressure-sensitive adhesive tape was then stuck to the bend and peeled to see removal of the coating film. Adhesion of the coating film was evaluated from crack formation and removal of the coating and ranked A (neither cracking nor peeling), B (cracking) or C (peeling). The results are shown in Table 1.

TABLE 1

| | Aqueous Dispersion Type | |
|---|---|---|
| No. | Polyurethane Composition | Adhesion |
| Evaluation 1-1 | No. 1 | A |
| Evaluation 1-2 | No. 2 | A |
| Evaluation 1-3 | No. 3 | A |
| Evaluation 1-4 | No. 4 | A |
| Comparative | Comp. 1 | C |
| Evaluation1-1 | | |
| Comparative | Comp. 2 | C |
| Evaluation1-2 | | |
| Comparative | Comp. 3 | C |
| Evaluation1-3 | | |

### Evaluation Example 2

### Measurement of Physical Properties

A JIS No. 2 dumbbell specimen having a thickness of 150 μm was prepared from the aqueous dispersion type polyurethane compositions obtained in Examples 1 to 4 and Comparative Examples 1 to 3 by drying at 25° C. for 12 hours followed by heat curing at 120° C. for 1 hour. A tensile test was carried out using the specimens at 25° C. under test conditions of a pulling speed of 500 mm/min and a span length of 40 mm to measure tensile strength and elongation. The results obtained are shown in Table 2.

TABLE 2

| | Aqueous | | | |
|---|---|---|---|---|
| | Dispersion Type | Tensile | | Tensile |
| | Polyurethane | Strength | Elongation | Strength/ |
| No. | Composition | (MPa) | (%) | elongation |
| Evaluation 2-1 | No. 1 | 17.5 | 500 | 0.035 |
| Evaluation 2-2 | No. 2 | 31.0 | 370 | 0.084 |
| Evaluation 2-3 | No. 3 | 41.0 | 385 | 0.106 |
| Evaluation 2-4 | No. 4 | 30.0 | 173 | 0.173 |
| Comparative | Comp. 1 | 5.0 | 300 | 0.017 |
| Evaluation2-1 | | | | |
| Comparative | Comp. 2 | 6.3 | 390 | 0.016 |
| Evaluation2-2 | | | | |
| Comparative | Comp. 3 | 5.0 | 320 | 0.016 |
| Evaluation2-3 | | | | |

### Evaluation Example 3

### Preparation of Waterborne Intercoating Composition and Valuation of Chip Resistance

In a reaction vessel equipped with a heater, a stirrer, a nitrogen introducing inlet, and a fractionating tower were put 348 parts by mass of neopentyl glycol, 150 parts by mass of trimethylolpropane, 128 parts by mass of adipic acid, and 435 parts of phthalic anhydride and allowed to react at 220° C. for 5 hours. To the reaction mixture was added 42 parts by mass of trimellitic anhydride and allowed to react at 160° C. for 1 hour. To the reaction mixture were further added 88 parts by mass of ε-caprolactone and 1 part by mass of dodecylbenzenesulfonic acid, followed by allowing the mixture to react at 150° C. for 3 hours to obtain a polyester resin having a weight average molecular weight of about 12,000, an acid value of 25, and a hydroxyl value of 110. A thousand parts by mass (on solid basis, hereinafter the same) of the polyester resin, 40 parts by mass of dimethylaminoethanol, 410 parts by mass of a blocked polyisocyanate compound of an adduct of a hexamethylene diisocyanate trimer (hexafunctional), 14 parts by mass of dibutyltin dilaurate, 1,400 parts by mass of titanium oxide white pigment, and 20 parts by mass of carbon black were dispersed in 1,800 parts by mass of deionized water to obtain a waterborne polyester resin coating.

The waterborne polyester resin coating and each of the aqueous dispersion type polyurethane composition Nos. 1 to 4 were mixed at a mass ratio of 75:25 to prepare waterborne coating Nos. 1 to 4. A comparative waterborne coating was prepared in the same manner using comparative aqueous dispersion type polyurethane composition 1 obtained in Comparative Example 1. Each of waterborne coating Nos. 1 to 4, the comparative waterborne coating, and the waterborne polyester resin coating (containing no aqueous dispersion type polyurethane composition) was applied to an electrocoated steel plate by spray coating and heated at 150° C. for 30 minutes to form a 25 μm thick coating film. Amilac White (from Kansai Paint Co., Ltd.) was sprayed thereon and heated at 140° C. for 30 minutes to form a 35 μm thick coating film. The resulting three layer coated steel plate was cooled to −25° C. and subjected to a stone chipping test with a gravelometer (from Suga Test Instruments Co., Ltd.) to evaluate chip resistance. In the gravelometer, 100 g of JIS No. 7 gravel was shot at the sample at an air pressure of 3.5 kg/cm² at an angle of 60. The results obtained are shown in Table 3.

TABLE 3

| | | Polyurethane | |
|---|---|---|---|
| | | Aqueous | |
| Evaluation | | Dispersion | |
| Run No. | Coating | Composition | Chip Resistance |
| Evaluation 3-1 | No. 1 | No. 1 | no chipping |
| Evaluation 3-2 | No. 2 | No. 2 | no chipping |
| Evaluation 3-3 | No. 3 | No. 3 | no chipping |
| Evaluation 3-4 | No. 4 | No. 4 | no chipping |
| Comparative | waterborne | — | chipping of upper |
| Evaluation3-1 | polyester resin | | coat |
| | coating | | |
| Comparative | comparative | Comp. 1 | chipping of upper |
| Evaluation3-2 | waterborne coating | | coat |

### INDUSTRIAL APPLICABILITY

The aqueous dispersion type polyurethane composition of the present invention provides a coating film with good adhesion to surfaces to be coated and satisfactory physical properties. The coating film imparts sufficient impact resistance to coating systems. The aqueous dispersion type polyurethane composition of the invention is suited as a member of automotive intercoating compositions.

1. An aqueous dispersion type polyurethane composition obtained from (a) a polyisocyanate component essentially comprising a diisocyanate and, optionally, other polyisocyanate compound, (b) a polyol component essentially comprising a polycarbonate diol having an average molecular weight of 500 to 5000 and a carboxyl-containing diol and, optionally, other polyol compound, (c) an amine component essentially comprising a monoamine compound and, optionally, a diamine compound, (d) a carboxyl-neutralizing component, and (e) water.

2. The aqueous dispersion type polyurethane composition according to claim 1, used as an automotive intercoating composition.

3. The aqueous dispersion type polyurethane composition according to claim 1, wherein the amine component (c) comprises the monoamine compound and the diamine compound.

4. The aqueous dispersion type polyurethane composition according to claim 1, wherein the ratio of the sum of the moles of hydroxyl group in the polyol component (b) and the moles of amino group in the amine component (c) to the moles of isocyanate group in the polyisocyanate component (a) is in the range of from 0.50 to 2.0.3

5. The aqueous dispersion type polyurethane composition according to claim 1, wherein the proportion of the diamine compound in the amine component (c) is 5 to 99 mol %.

6. The aqueous dispersion type polyurethane composition according to claim 1, wherein the monoamine compound of the amine component (c) is an alkanolamine.

7. The aqueous dispersion type polyurethane composition according to claim 2, wherein the amine component (c) comprises the monoamine compound and the diamine compound.

8. The aqueous dispersion type polyurethane composition according to claim 2, wherein the ratio of the sum of the moles of hydroxyl group in the polyol component (b) and the moles of amino group in the amine component (c) to the moles of isocyanate group in the polyisocyanate component (a) is in the range of from 0.50 to 2.0.3

9. The aqueous dispersion type polyurethane composition according to claim 3, wherein the ratio of the sum of the moles of hydroxyl group in the polyol component (b) and the moles of amino group in the amine component (c) to the moles of isocyanate group in the polyisocyanate component (a) is in the range of from 0.50 to 2.0.3

10. The aqueous dispersion type polyurethane composition according to claim 2, wherein the proportion of the diamine compound in the amine component (c) is 5 to 99 mol %.

11. The aqueous dispersion type polyurethane composition according to claim 3, wherein the proportion of the diamine compound in the amine component (c) is 5 to 99 mol %.

12. The aqueous dispersion type polyurethane composition according to claim 4, wherein the proportion of the diamine compound in the amine component (c) is 5 to 99 mol %.

13. The aqueous dispersion type polyurethane composition according to claim 2, wherein the monoamine compound of the amine component (c) is an alkanolamine.

14. The aqueous dispersion type polyurethane composition according to claim 3, wherein the monoamine compound of the amine component (c) is an alkanolamine.

15. The aqueous dispersion type polyurethane composition according to claim 4, wherein the monoamine compound of the amine component (c) is an alkanolamine.

16. The aqueous dispersion type polyurethane composition according to claim 5, wherein the monoamine compound of the amine component (c) is an alkanolamine.
